(19) United States
(12) Patent Application Publication
(10) Pub. No.: US 2010/0039034 A1
(43) Pub. Date: Feb. 18, 2010

(54) PHOTOCURABLE CONDUCTIVE PASTE AND PHOTOCURABLE BLACK PASTE USED IN FORMATION OF BUS ELECTRODE HAVING DOUBLE LAYER STRUCTURE, AND PLASMA DISPLAY PANEL

(76) Inventors: Hideyuki Ito, Hiki-gun (JP); Nobuyuki Suzuki, Hiki-gun (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/605,701

(22) Filed: Oct. 26, 2009

Related U.S. Application Data
(62) Division of application No. 12/257,829, filed on Oct. 24, 2008.
Application No. 12/257,829 is a continuation of application No. PCT/JP07/59075, filed on Apr. 26, 2007.

(30) Foreign Application Priority Data
Apr. 26, 2006 (JP) 2006-122458

(51) Int. Cl. H01J 17/49; H02G 5/00

(52) U.S. Cl. 313/583; 174/68.2

(57) ABSTRACT

The invention relates to a photocurable conductive paste which is a conductive paste (A) used to form the upper layer of a bus electrode having a double-layer structure including two layers differing in contrast, the conductive paste (A) containing a glass powder (A1) having a softening point 40° C. or more higher than a glass powder (B1) of a black paste (B) to be used in the lower layer, a conductive powder (A2), an organic binder (A3), a photopolymerizable monomer (A4) and a photopolymerization initiator (A5).

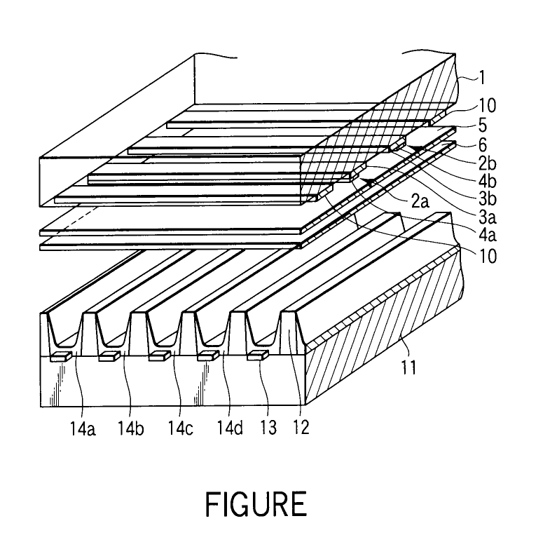

### CROSS REFERENCE TO RELATED APPLICATIONS

This is a Divisional Application of and claims the benefit of priority from U.S. patent Ser. No. 12/257,829, filed Oct. 24, 2008 which is a Continuation Application of PCT Application No. PCT/JP2007/059075, filed Apr. 26, 2007, which was published under PCT Article 21(2) in Japanese.

U.S. patent Ser. No. 12/257,829 is based upon and claims the benefit of priority from prior Japanese Patent Application No. 2006-122458, filed Apr. 26, 2006, the entire contents of which are incorporated herein by reference.

### BACKGROUND OF THE INVENTION

1. Field of the Invention

The present invention relates to a photocurable conductive paste and a photocurable black paste used to form a bus electrode having a double layer structure consisting of two layers differing in contrast in a plasma display panel (hereinafter abbreviated as “PDP”), and to a plasma display panel. The present invention relates, particularly to a photoconductive paste used to form a bus electrode having a double layer structure having stable layer conductivity, to a photocurable black paste which has stable inter-black layer resistance even in the case of high-temperature baking, is not impaired in excellent adhesion to a substrate, resolution and baking characteristics in drying, exposure, developing and baking steps and can form a baked coating film having sufficient blackness after the baking step, and to a plasma display panel.

2. Description of the Related Art

PDPs are flat displays that display images and information by utilizing the emission of plasma discharge, and are classified into a DC-type and an AC-type according to the panel structure/drive method. To explain the principle of color display of PDPs, plasma discharge is made to occur in a cell space (discharge space) between both electrodes which are disposed opposite to each other and are formed on a front glass substrate and back glass substrate spaced apart by a rib (dividing wall) respectively, to excite a fluorescent body formed on the inside surface of the back glass substrate by the ultraviolet rays generated by the discharge of gases such as He and Xe sealed in each cell space, thereby generating visible light having the three primary colors. Each cell space is divided by lattice-like ribs in DG-type PDPs and by ribs arranged in parallel to the surface of the substrates in AC-type PDPs. In any type of PDP, the division of each cell space is made by the ribs. This structure is briefly explained with reference to the drawings attached hereto.

FIGURE shows a part of a structural example of a full-color display plane discharge system PDP having a three-electrode structure. A large number of paired display electrodes 2a and 2b, including a transparent electrode 3a or 3b for discharge and a bus electrode 4a or 4b used to reduce the line resistance of the transparent electrode, are formed at a specified pitch on the backside of a front glass substrate 1. A transparent dielectric layer 5 (low-melting point glass) that accumulates charges is formed on each of these display electrodes 2a and 2b by printing or baking, and a protective layer (MgO) 6 is vapor-deposited on the transparent dielectric layer 5. The protective layer 6 is, for example, for the protection of the display electrode and for the retention of a discharge state. On the back glass substrate 11, on the other hand, a large number of rib strips (dividing walls) 12 that divide a discharge space and a large number of address electrodes (data electrode) 13 disposed in each discharge space are disposed at specified pitches. Also, fluorescent films having three colors, that is, red (14a), blue (14b) and green (14c) respectively are regularly arranged in each discharge space. In a full-color display, the fluorescent films having three primary colors, that is, red, blue and green constitute one pixel.

Moreover, black patterns 10, 10 having the same strip form are formed on both side parts of the paired display electrodes 2a and 2b forming the discharge space to more improve the contrast of an image.

In a PDP having the above structure, an AC pulse voltage is applied across the pair of display electrodes 2a and 2b to allow discharge between electrodes on the same substrate and therefore, this system is called a “plane discharge system”.

Also, in the PDP having such as structure, the ultraviolet rays generated by discharging excite the fluorescent films 14a, 14b and 14c on the back substrate 11, which generates visible light, which then passes through the transparent electrodes 3a and 3b of the front substrate 1.

In the formation of the above bus electrodes 4a and 4b in current PDPs having such a structure, patterning is carried out by a photographic method after three layers, that is, Cr—Cu—Cr layers are formed by vapor deposition or by sputtering.

However, many steps are required, which increases the production cost. This is the reason of the adoption of a method in which a conductive paste such as a silver paste is applied by screen printing, followed by baking or a method in which a photosensitive conductive paste is applied, exposed through a patterned mask and developed, followed by baking to obtain a line width of 150 mm or less.

In the front substrate of a PDP formed with the bus electrodes 4a and 4b, such a method is currently performed in which, in the formation of the bus electrode, a black paste is formed on the lower layer (layer which is in contact with the transparent electrodes 3a and 3b) which is disposed on the display side by printing, and a conductive paste is applied to the above black paste by printing to form a structure including two layers differing in contrast, thereby improving the contrast of a display. Also, in the formation of a black pattern, such a method is performed in which a black paste is applied, exposed through a patterned mask and developed, followed by baking. However, in a currently used method, the lower layer and black pattern layer in the bus electrode having a double layer structure including two layers differing in contrast are formed using the same material for simplifying the production process (see Patent Document 1).

The lower layer of the bus electrode having a double layer structure including two layers differing in contrast is sandwiched between the upper conductive paste layer and the transparent electrode to form a sandwich structure and therefore, it is required for the lower layer to have conductivity. The resistance of the black layer sandwiched between the conductive paste layer and the transparent electrode is preferably lower.

However, because the baking of the bus electrode is performed at higher temperatures, the inter-black layer resistance tends to increase because of the high-temperature heat history during the baking time. One of the reasons is considered to be that glass contained in the conductive paste layer of the bus electrode moves to the inside of the black layer when the temperature of the system is high.

[Patent Document 1] Jpn. Pat. Appln. KOKAI Publication No. 2000-251744 (claims)

### BRIEF SUMMARY OF THE INVENTION

In view of the above situation, the present invention has been made to solve the problem involved in the prior art and it is an object of the invention to provide a photocurable conductive paste used to form a bus electrode having a double-layer structure including two layers differing in contrast, and a photocurable black paste. As the photocurable black paste, the present invention provides a photocurable black paste which has stable inter-black layer resistance even in the case of high-temperature baking, is not impaired in excellent adhesion to a substrate, resolution and baking characteristics in drying, exposure, developing and baking steps and can form a baked coating film having sufficient blackness after the baking step, to thereby secure excellent discharge characteristics.

Another object of the present invention is to provide a plasma display panel formed with a highly precise electrode circuit and, particularly, an electrode circuit which is formed on the front substrate and satisfies stable layer conductivity (layer conduction between the transparent electrode and the bus electrode layer) in a bus electrode having a double-layer structure including two layers differing in contrast, and with a black pattern from the photocurable conductive paste and the photocurable black paste.

In order to achieve the above-described object, a first aspect of the invention provides a photocurable conductive paste, which is a conductive paste (A) used to form the upper layer of a bus electrode having a double-layer structure including two layers differing in contrast, the conductive paste (A) containing a glass powder (A1) having a softening point 40° C. or more higher than a glass powder (B1) of a black paste (B) to be used in the lower layer, a conductive powder (A2), an organic binder (A3), a photopolymerizable monomer (A4) and a photopolymerization initiator (A5).

A second aspect of the invention provides a photocurable black paste, which is a black paste (B) used to form the lower layer of a bus electrode having a double-layer structure including two layers differing in contrast, the black paste (B) containing a glass powder (B1) having a softening point 40° C. or more lower than a glass powder (A1) of a photocurable conductive paste (A) to be used in the upper layer, a heat-resistant black pigment (B2), an organic binder (B3), a photopolymerizable monomer (B4) and a photopolymerization initiator (B5).

Such a photocurable conductive paste and a photocurable black paste according to the present invention may be provided in the form of a dry film by making a film.

A third aspect of the invention provides a plasma display panel provided with a front glass substrate formed with a bus electrode having a double layer structure consisting of a white layer and a black layer and a black pattern, wherein the white layer is formed using the photocurable conductive paste (A) and the black layer and black pattern are formed using the same photocurable black paste (B).

A fourth aspect of the invention provides a bus electrode provided with a double-layer structure having a white layer and a black layer, wherein a difference in glass softening point between a glass powder (A1) contained in the white layer and a glass powder (B1) contained in the black layer is 40° C. or more, the softening point of the glass powder (A1) is 520 to 600° C. and the black layer contains a heat-resistant black pigment (B2).

In the photocurable resin composition of the present invention, stable layer conductivity can be obtained in the lower layer of the bus electrode having a double-layer structure even if the lower layer of the bus electrode having a double-layer structure including two layers differing in contrast and the black pattern layer are formed using the same material. Therefore, the photocurable resin composition is very useful in view of the productivity of PDPs and a reduction in the cost of PDPs.

### BRIEF DESCRIPTION OF THE SEVERAL VIEWS OF THE DRAWING

The single FIGURE is a partially exploded perspective view of a plane discharge system AC-type PDP.

### DETAILED DESCRIPTION OF THE INVENTION

The inventors of the present invention have conducted much research to attain the above object, and as a result, have found that the layer resistance of the formed bus electrode is stable, with the result, that a baked film (the lower layer of the bus electrode and the black pattern) having sufficient blackness after a baking step without impairing excellent adhesion to a substrate, sufficient resolution and baking characteristics in drying, exposure, developing and baking steps, is produced by using a glass powder (A1) having a softening point 40° C. or more higher than the glass powder (B1) of the black paste (B), and preferably a glass powder (A1) having a softening point of 520 to 600° C. as the photocurable conductive paste (A), to complete the present invention.

Also, when the photocurable conductive paste (A) of the present invention is used, the lower layer of the bus electrode having a double-layer structure including two layers differing in contrast and the black pattern layer are formed using the same material for simplifying the production process, as mentioned above. Therefore, the photocurable conductive paste (A) is very useful in view of the productivity of PDPs and a reduction in the cost of PDPs.

The conductive paste (A) of the present invention, which is used to form a bus electrode having a double-layer structure including two layers differing in contrast, contains a glass powder (A1) (hereinafter abbreviated as “white layer glass powder”) which has a softening point 40° C. or more, preferably 40 to 100° C. and more preferably 50 to 80° C. higher than the glass powder (B1) (hereinafter abbreviated as “black layer glass powder) of the black paste (B) used in the lower layer.

The softening point of the black layer glass powder (B1) is preferably 400 to 540° C., and more preferably 450 to 520° C. The softening point of the white layer glass powder (A1) is preferably 520 to 600° C., and more preferably 520 to 580° C. in consideration of better adhesiveness.

The conductive paste (A) of the present invention which is used to form a bus electrode having a double-layer structure including two layers differing in contrast is a photocurable conductive paste containing the glass powder (A1) having a softening point 40° C. or more, preferably 40 to 100° C. and more preferably 50 to 80° C. higher than the glass powder (B1) of the black paste (B) used in the black layer, a conductive powder (A2), an organic binder (A3), a photopolymerizable monomer (A4) and a photopolymerization initiator (A5).

Also, the black paste (B) of the present invention, which is used to form a bus electrode having a double-layer structure including two layers differing in contrast, is a photocurable black paste containing the glass powder (B1) having a softening point 40° C. or more lower than the above glass powder (A1), a heat-resistant black pigment (B2), an organic binder (B3), a photopolymerizable monomer (B4) and a photopolymerization initiator (B5). A preferred embodiment of the above photocurable black paste is a composition prepared by further blending an inorganic powder (B6), preferably an inorganic powder having a volume specific resistance of 1×10⁴ Ω·cm or less and more preferably a lanthanum composite oxide represented by the formula, La₁₋ₓSrₓCoO₃ or La₁₋ₓSrₓMnO₃ other than the above glass powder (B1) and heat-resistant black pigment (B2) in the above photocurable paste.

Each structural component of the photocurable conductive paste and photocurable black paste used in the formation of the bus electrode having a double-layer structure including two-layers differing in contrast according to the present invention will be explained in detail.

As the glass powder (A1) used in the photocurable conductive paste (A) of the present invention, one having a softening point 40° C. or more, preferably 40 to 100° C. and more preferably 50 to 80° C. higher than the glass powder (B1) of the black paste (B) used in the black layer is used.

Specifically, the softening point is preferably 520 to 600° C., and more preferably 520 to 580° C. in consideration of, for example, adhesion. Such glass powders (A1) may be used in combinations of two or more.

When the glass powder (A1) as mentioned above is added in the photocurable conductive paste (A), the coating film after the exposure and developing steps can be baked at 600° C. or less with ease. A highly combustible organic binder is used in the composition of the present invention and the composition is so devised that the removal of the binder is finished before the glass powder is melted. However, if the softening point of the glass powder is 400° C. or less, this is undesirable because the glass melts at a temperature less than the above temperature and easily covers the organic binder, causing the residual organic binder to be decomposed, whereby blistering easily arises in the composition.

As the glass powder (A1), an amorphous frit containing bismuth oxide, zinc oxide, or the like as the major component is preferably used. Also, it is preferable to use a glass powder having an average particle diameter of 20 mm or less and preferably 5 mm or less from the viewpoint of resolution.

Preferable examples of the glass frit containing bismuth oxide as the major component include an amorphous frit having a composition containing 6 to 88% Bi₂O₃, 5 to 30% B₂O₃, 5 to 25% SiO₂, 0 to 5% Al₂O₃, 0 to 20% BaO and 1 to 20% ZnO by weight based on the oxide and a softening point of 520 to 600° C.

Preferable examples of the glass frit containing zinc oxide as the major component include an amorphous frit having a composition containing 25 to 60% ZnO, 2 to 15% K₂O, 25 to 45% B₂O₃, 1 to 7% SiO₂, 0 to 10% Al₂O₃, 0 to 20% BaO and 0 to 10% MgO by weight based on the oxide and a softening point of 520 to 600° C.

The amount of the glass powder (A1) like this is properly 1 to 7% by weight in the above photocurable conductive paste (A). When the amount of the glass powder is less than the above range, this is undesirable because, for example, the strength of the electrode is decreased, whereas when the amount exceeds the above range, this is undesirable because only insufficient conductivity may obtained.

Examples of the conductive powder (A2) to be used in the photocurable conductive paste (A) of the present invention include silver, copper, nickel, gold and aluminum. Particularly, silver (A2-1) is preferably used. As to the shape of the particles of these conductive powders (A2), spherical particles are preferably used in consideration of optical characteristics and dispersibility though flake particles or resin-like particles may also be used. Also, as to the average particle diameter of the conductive powder, powders having an average particle diameter of 10 mm or less and preferably 5 mm or less are preferably used in view of the resolution. Also, for the prevention of oxidation of the conductive metal powders, an improvement in dispersibility in the composition and stabilization of developing, particularly, silver, nickel and aluminum is preferably subjected to treatment using fatty acid. Examples of the fatty acid include oleic acid, linoleic acid linolenic acid and stearic acid.

The amount of the conductive powder (A2) to be compounded is properly 50 to 90% by weight in the above photocurable conductive paste (A). When the amount of the conductive powder to be compounded is less than the above range, sufficient conductivity of the conductive pattern produced using the paste is not obtained, whereas when the amount of the conductive powder (A2) is increased so much as to exceed the above range, the adhesion to the substrate is impaired, therefore an amount out of the above range is not preferable.

The organic binder (A3) used in the photocurable conductive paste of the present invention may be used as the organic binder (B3) for the black paste which will be explained later. As the organic binder (A3) like this, a resin having a carboxyl group and specifically, a carboxyl group-containing photosensitive resin itself having an ethylenic unsaturated double bond and a carboxyl group-containing resin having no ethylenic unsaturated double bond may be both used. Specifically, the following examples are given.

(1) A carboxy group-containing resin obtained by copolymerizing an unsaturated carboxylic acid such as a (meth)acrylic acid with a compound having an unsaturated double bond such as methyl(meth)acrylate.

(2) A carboxy group-containing photosensitive resin obtained by adding an ethylenic unsaturated group as a pendant to a copolymer of an unsaturated carboxylic acid such as a (meth)acrylic acid and a compound having an unsaturated double bond such as methyl(meth)acrylate by using glycidyl(meth)acrylate, (meth)acrylic acid chloride or the like.

(3) A carboxy group-containing photosensitive resin obtained by reacting an unsaturated carboxylic acid such as (meth)acrylic acid with a copolymer of a compound having an epoxy group and an unsaturated double bond such as glycidyl(meth)acrylate and a compound having an unsaturated double bond such as methyl(meth)acrylate and by reacting a polybasic acid anhydride such as tetrahydrophthalic acid anhydride with the produced secondary hydroxyl group.

(4) A carboxyl group-containing photosensitive resin obtained by reacting a compound, such as 2-hydroxyethyl(meth)acrylate, containing a hydroxyl group and an unsaturated double bond with a copolymer of an acid anhydride having an unsaturated double bond such as maleic acid anhydride and a compound having an unsaturated double bond such as styrene.

(5) A carboxy group-containing resin obtained by reacting a polyfunctional epoxy compound with an unsaturated monocarboxylic acid such as a (meth)acrylic acid and by reacting a polybasic acid anhydride such as tetrahydrophthalic acid anhydride with the produced secondary hydroxyl group.

(6) A carboxyl group-containing resin obtained by reacting an organic acid having one carboxyl group in one molecule and no ethylenic unsaturated bond with an epoxy group of a copolymer of compound such as a methyl(meth)acrylate having an unsaturated double bond and a glycidyl(meth)acrylate, and by reacting a polybasic acid anhydride with the produced secondary hydroxyl group.

(7) A carboxyl group-containing resin obtained by reacting a polybasic acid anhydride with a hydroxyl group-containing polymer such as a polyvinyl alcohol

(8) A carboxyl group-containing photosensitive resin obtained by further reacting a compound, such as glycidyl(meth)acrylate, having an epoxy group and an unsaturated double bond with a carboxyl group-containing resin obtained by reacting a polybasic acid anhydride such as tetrahydrophthalic acid anhydride with a hydroxyl group-containing polymer such as a polyvinyl alcohol. Among these compounds, particularly, resins of the above (1), (2), (3) and (6) are preferably used.

It is to be noted that the term, “(meth)acrylate” is a generic term representing acrylates, methacrylates and mixtures of these compounds, and this applies to the other analogous expressions.

This carboxyl group-containing resin and carboxyl group-containing photosensitive resin may be used either singly or in combination. In any case, these resins are preferably blended in a total ratio of 9 to 80% by weight based on the total amount of the composition. When the amount of these polymers is too small, or out of the above range, the distribution of the above resin in the formed coating film tends to be non-uniform, thus making it difficult to obtain sufficient photocurability and photo-cured depth, making it difficult to carry out patterning through selective exposure and developing. When the amount of these resins is too large, or out of the above range, this tends to be a cause of a twist of the pattern and shrinkage of line width, which is undesirable.

As each of the above carboxyl group-containing resin and carboxyl group-containing photosensitive resin, a resin having a weight average molecular weight of 1,000 to 100,000, and preferably 5,000 to 70,000, an acid value of 50 to 250 mg KOH/g and also, a double bond equivalent of 350 to 2,000 and preferably 400 to 1,500 in the case of the carboxyl group-containing photosensitive resin is preferably used. When the molecular weight of the above resin is less than 1,000, this adversely affects the adhesion of the coating film during developing, whereas when the molecular weight exceeds 100,000, this is undesirable because development defect tend to occur. Also, when the acid value is less than 50 mg KOH/g, the solubility of the resin in an aqueous alkali solution is insufficient and development defect tend to occur, whereas when the acid value exceeds 250 mg/KOH, this is undesirable because a deterioration in adhesion and the dissolution of the photo-cured part (exposed portion) of the coating film arise during developing. Moreover, in the case of the carboxyl group-containing photosensitive resin, a residue tends to remain in the baking process when the double bond equivalent of the photosensitive resin is less than 350, whereas the working allowance is narrow during developing and a high exposure amount is required during photo-curing when the double bond equivalent of the photosensitive resin exceeds 2,000.

The photopolymerizable monomer (A4) to be used in the photocurable conductive paste of the present invention may be used as the photopolymerizable monomer (B4) of the black paste. The photopolymerizable monomer (A4) or (B4) is used to promote the photocurability of the composition and to improve the developing ability of the composition. Examples of the photopolymerizable monomer (A4) or (B4) include 2-hydroxyethylacrylate, 2-hydroxypropylacrylate, diethylene glycol diacrylate, triethylene glycol diacrylate, polyethylene glycol diacrylate, polyurethane diacrylate, trimethylolpropane triacrylate, pentaerythritol triacrylate, pentaerythritol tetraacrylate, trimethyloWWlpropaneethylene oxide modified triacrylate, trimethylolpropanepropylene oxide modified triacrylate, dipentaerythritol pentaacrylate, dipentaerythritol hexaacrylate and methacrylates corresponding to each of these acrylates; mono-, di- or tri- or higher polyesters of a polybasic acid such as phthalic acid, adipic acid, maleic acid, itaconic acid, succinic acid, trimellitic acid or terephthalic acid and a hydroxyalkyl (meth)acrylate. However, the monomer is not limited to a specific one and also, these materials may be used either singly or in combinations of two or more. Among these photopolymerizable monomers, polyfunctional monomers having two or more acryloyl groups or methacryloyl groups in one molecule are preferable.

The amount of the photopolymerizable monomer (A4) or (B4) to be compounded is properly 20 to 100 parts by weight based on 100 parts by weight of the above organic binder (carboxyl group-containing photosensitive resin and/or carboxyl group-containing resin) (A3) or (B3). When the amount of the photopolymerizable monomer (A4) or (B4) to be compounded is less than the above range, sufficient photocurability of the composition is scarcely obtained, whereas when the amount is so large as to exceed the above range, the rate of the photo-curing of the surface part is higher than that of the deep part of the coating film, so that curing unevenness tends to occur.

The photopolymerization initiator (A5) to be used in the photocurable conductive paste of the present invention may be used as the photopolymerization initiator (B5) of the black paste which will be explained later. Specific examples of the photopolymerization initiator (A5) or (B5) include benzoin or benzoin alkyl ethers such as benzoin, benzoin methyl ether, benzoin ethyl ether and benzoin isopropyl ether; acetophenones such as acetophenone, 2,2-dimethoxy-2-phenylacetophenone, 2,2-diethoxy-2-phenylacetophenone and 1,1-dichloroacetophenone; aminoacetophenones such as 2-methyl-1-[4-(methylthio)phenyl]-2-morpholinopropan-1-one, 2-benzyl-2-dimethylamino-1-(4-morpholinophenyl)-butanone-1 and 2-(dimethylamino)-2-[(4-methylphenyl)methyl]-1-[4-(4-morpholinyl)phenyl]-1-butanone; anthraquinones such as 2-methylanthraquinone, 2-ethylanthraquinone, 2-t-butylanthraquinone and 1-chloroanthraquinone; thioxanthones such as 2,4-dimethylthioxanthone, 2,4-diethylthioxanthone, 2-chlorothioxanthone and 2,4-diisopropylthioxanthone; ketals such as acetophenone dimethyl ketal and benzyl dimethyl ketal; benzophenones such as benzophenone; or xanthones; phosphine oxides such as (2,6-dimethoxybenzoyl)-2,4,4-pentylphosphine oxide, bis(2,4,6-trimethylbenzoyl)-phenylphosphine oxide, 2,4,6-trimethylbenzoylphenylphosphine oxide and ethyl-2,4,6-trimethylbenzoylphenyl phosphinate; and various peroxides. These known and usual photopolymerization initiators may be used either singly or in combinations of two or more.

The ratio of these photopolymerization initiators (A5) or (B5) to be compounded is properly 1 to 30 parts by weight and preferably 5 to 20 parts by weight based on 100 parts by weight of the above organic binder (carboxyl group-containing photosensitive resin and/or carboxyl group-containing resin) (A3) or (B3).

As the photopolymerization initiator (A5) or (B5) as mentioned above, photosensitizers such as tertiary amines including ethyl N,N-dimethylaminobenzoate, isoamyl N,N-dimethylaminobenzoate, pentyl-4-dimethylaminobenzoate, triethylamine and triethanolamine may be used either singly or in combinations of two or more according to the need.

When a higher photo-curing depth is required, a titanocene type photopolymerization initiator such as Irgacure 784 (manufactured by Ciba Specialty Chemicals Inc.) which enters into a radical reaction in the visible region and a leuco dye may be combined as curing adjuvants prior to use according to the need.

When a higher photo-curing depth is required, a thermal polymerization catalyst may be used in combination with the above photopolymerization initiator (A5) or (B5) according to the need. This thermal polymerization catalyst is capable of reacting an uncured photopolymerizable monomer by aging at high temperatures for about several minutes to about one hour. Specific examples of the catalyst include peroxides such as benzoyl peroxide and azo compounds such as azoisobutyronitrile. Preferable examples of the catalyst include 2,2′-azobisisobutyronitrile, 2,2′-azobis-2-methylbutyronitrile, 2,2′-azobis-2,4-divaleronitrile, 1′-azobis-1-cyclohexanecarbonitrile, dimethyl-2,2′-azobisisobutylate, 4,4′-azobis-4-cyanovaleric acid, 2-methyl-2,2′-azobispropanenitrile, 2,4-dimethyl-2,2,2′,2′-azobispentanitrile, 1,1′-azobis(1-acetoxy-1-phenylethane), 2,2,2′,2′-azobis(2-methylbutanamideoxime)dihydrochloride. More preferable examples include 1,1′-azobis(1-acetoxy-1-phenylethane) which is a non-cyan and non-halogen type non-harmful to environment.

Next, the photocurable black paste (B) to be used in the formation of a bus electrode having a double-layer structure including two layers differing in contrast according to the present invention will be explained.

The photocurable black paste (B) of the present invention is a photocurable black paste containing a glass powder (B1), a heat-resistant black pigment (B2), an organic binder (B3), a photopolymerizable monomer (B4) and a photopolymerization initiator (B5).

In a preferred embodiment, the photocurable black paste (B) is a composition further including an inorganic powder (B6) other than the above glass powder (B1) and heat-resistant black pigment (B2), and is preferably an inorganic powder having a volume specific resistance of 1×10⁴ Ω·cm or less and more preferably a lanthanum composite oxide represented by the formula, La₁₋ₓSrₓCoO₃ or La₁₋ₓSrₓMnO₃.

As the glass powder (B1) to be used in the photocurable black paste (B) of the present invention, a glass powder having a softening point lower by 40° C. or more, preferably 40 to 100° C. and more preferably 50 to 80° C. than the glass powder (A1) used in the above photocurable conductive paste (A) is used, though the same material as the glass powder (A1) used in the foregoing photocurable conductive paste (A) may be basically used.

The amount of the black layer glass powder (B1) to be compounded is properly in a range from 1 to 300 parts by weight and preferably in a range from 10 to 200 parts by weight based on 100 parts by weight of the heat-resistant black pigment (B2). This is because if the amount of the black layer glass powder to be compounded is less than the above range, only insufficient adhesion is obtained after baking whereas if the amount exceeds the above range, only insufficient blackness is obtained, which is undesirable.

Also, it is preferable to use a glass powder having an average particle diameter of 10 mm or less and preferably 3 mm or less from the viewpoint of resolution.

As the heat-resistant black pigment (B2) used in the photocurable black paste (B) of the present invention, tricobalt tetroxide is preferably used. However, the heat-resistant black pigment (B2) is not limited to this, and oxides or composite oxides of Cr, Cu, Fe, Ni, Mn, Ru, La, Sr and the like may be combined prior to use.

The amount of the heat-resistant black pigment (B2) to be compounded is properly 10 to 200 parts by weight and preferably 20 to 100 parts by weight based on 100 parts by weight of the organic binder (B3). This is because if the amount of the heat-resistant black pigment (B2) to be compounded is less than the above range, only insufficient blackness is obtained after baking, whereas if the amount exceeds the above range, light transmittance is deteriorated, resulting in deteriorated pattern formation, which is undesirable.

As the organic binder (B3) to be used in the photocurable black paste (B) of the present invention, the same binder as the organic binder (A3) used in the above photocurable conductive paste is used. That is, a resin having a carboxyl group, and specifically, a carboxyl group-containing photosensitive resin which itself has an ethylenic unsaturated double bond and a carboxyl group-containing resin having no ethylenic unsaturated double bond may be both used.

As the photopolymerizable monomer (A4) used in the photocurable black paste (B) of the present invention, the same monomer as the photopolymerizable monomer (A4) used in the above photocurable conductive paste is used.

As the photopolymerization initiator (B5) used in the photocurable black paste (B) of the present invention, the same photopolymerization initiator as the photopolymerization initiator (A5) used in the above photocurable conductive paste is used.

The inorganic powder (B6) other than the above glass powder (B1) and heat-resistant black pigment (B2) used in a preferred embodiment of the photocurable black paste of the present invention is used for the purpose of reducing the resistance of inter black layer and is an inorganic powder having a volume specific resistance of 1×10⁴ Ω·cm or less. Specific examples of the inorganic powder include oxides or composite oxides of Cr, Fe, Ir, Mn, Mo, Nb, Os, Pt, Re, Rh, Ru, Ti, Cu, Ni, La, Sr, Co and the like, and particularly, a lanthanum composite oxide represented by the formula, La₁₋ₓSrₓCoO₃ or La₁₋ₓSrₓMnO₃ is used. However, the inorganic powder in the present invention is not limited to these compounds, and these compounds may be used either singly or in combinations of two or more.

The ratio of the inorganic powder (B6) other than the above glass powder (B1) and heat-resistant black pigment (B2) to be compounded is preferably in a range from 10 to 120 parts by weight based on 100 parts by weight of the above heat-resistant black pigment (B2). This is because if the amount of the inorganic powder (B6) to be compounded is less than the above range, it is difficult to obtain sufficient layer conduction after baking in the black layer of the bus electrode having a white-black double layer structure, whereas if the amount of the inorganic powder exceeds the above range, there is the possibility of erroneous discharge in the black pattern layer, which is undesirable.

In the photocurable conductive paste and the photocurable black paste in the present invention, there is a tendency that the storage stability of the obtained composition is impaired and coating workability is impaired due to gelation, as well as a deterioration in fluidity when a large amount of an inorganic powder is compounded in the photocurable resin composition. Therefore, in the composition of the present invention, a compound having effects on the formation of a complex or salt of a metal which is a component of the inorganic powder or an oxide powder may be added as a stabilizer to improve the storage stability of the composition. Examples of the stabilizer include inorganic acids such as a boric acid and organic acids such as formic acid, acetic acid, acetoacetic acid, citric acid, stearic acid, maleic acid, fumaric acid, phthalic acid, benzenesulfonic acid and sulfamic acid; besides, various phosphoric acid compounds (inorganic phosphoric acids and organic phosphoric acids) such as phosphoric acid, phosphorous acid, hypophosphorous acid, methyl phosphate, ethyl phosphate, butyl phosphate, phenyl phosphate, ethyl phosphite, diphenyl phosphite and mono(2-methacryloyloxyethyl) acid phosphate. These materials may be used either singly or in combinations of two or more.

In the present invention, a proper amount of an organic solvent may be compounded to dilute the composition into a paste, thereby making possible to carry out a coating step easily and then to dry the coating film, thereby forming a layer to enable contact exposure. Specific examples of the solvent include ketones such as methyl ethyl ketone and cyclohexanone; aromatic hydrocarbons such as toluene, xylene and tetramethylbenzene; glycol ethers such as cellosolve, methyl cellosolve, carbitol, methyl carbitol, butyl carbitol, propylene glycol monomethyl ether, dipropylene glycol monomethyl ether, dipropylene glycol monoethyl ether and triethylene glycol monoethyl ether; esters such as ethyl acetate, butyl acetate, cellosolve acetate, butyl cellosolve acetate, carbitol acetate, butyl carbitol acetate, propylene glycol monomethyl ether acetate, 2,2,4-trimethyl-1,3-pentanediol monoisobutylate; alcohols such as ethanol, propanol, ethylene glycol, propylene glycol and terpineol; aliphatic hydrocarbons such as octane and decane; petroleum type solvents such as petroleum ether, petroleum naphtha, hydrogenated petroleum naphtha and solvent naphtha and 2,2,4-trimethyl-1,3-pentanediolmonoisobutylate. These compounds may be used either singly or in combinations of two or more.

The photocurable conductive paste and photocurable black paste according to the present invention may be, as required, blended with other additives such as a silicone type or acryl type antifoaming and leveling agent and a silane coupling agent used to improve the adhesion of the coating film and a cationic, anionic or nonionic pigment dispersing agent according to the need. Moreover, according to the need, known and usual antioxidants, thermal polymerization inhibitors used to improve thermal stability when the paste is stored, and microparticles of metal oxides, silicon oxides and boron oxides which are components binding the substrate during baking may be added.

The photocurable conductive paste and photocurable black paste according to the present invention may be laminated in the substrate when these materials are respectively formed into a film in advance. In the case of a paste-like composition, the paste is applied to a substrate, for example, a glass substrate, which is to be the front substrate of a PDP, by using an appropriate method, such as screen printing or a method using a bar coater or blade coater. Then, in order to obtain satisfactory characteristics concerning dry to touch, the substrate is dried at about 60 to 120° C. for about 5 to 40 minutes in a hot air circulation system drier, far infrared drying furnace or the like to vaporize the organic solvent to obtain a tuck-free coating film. Then, selective exposure, developing and baking are carried out to form an electrode circuit having a specified pattern and a black pattern.

In the exposure step, contact exposure or non-contact exposure using a negative mask having a specified exposure pattern can be carried out. As the exposure light source, a halogen lamp, high-pressure mercury lamp, laser light, metal halide lamp or non-electrode lamp is used. The exposure amount is preferably about 50 to 1000 mJ/cm².

In the developing step, a spraying method or a dipping method is used. As the developing solution, an aqueous solution of a metal alkali such as sodium hydroxide, potassium hydroxide, sodium carbonate, potassium carbonate or sodium silicate or an aqueous solution of an amine such as monoethanolamine, diethanolamine or triethanolamine, and, particularly, an aqueous dilute alkali solution having a concentration of about 1.5% by weight or less is preferably used. In this developing step, it is only required to saponify a carboxyl group of a carboxyl group-containing resin in the composition and to remove the uncured part (unexposed part), and the developing solution is not limited to the above compounds. Also, it is preferable to carry out washing with water and neutralization using an acid to remove unnecessary developing solution after developing.

In the baking step, the developed substrate is heat-treated in an air or nitrogen atmosphere at about 500 to 600° C. to form a desired pattern.

### EXAMPLES

The present invention will be explained in detail by way of examples, which are, however, not intended to limit the present invention. In these examples, all designations of parts indicate parts by weight, unless otherwise noted.

### Synthetic Example 1

A flask equipped with a temperature gage, a stirrer, a dropping funnel and a reflux condenser was charged with methylmethacrylate and methacrylic acid in a molar ratio of 0.76:0.24, to which was added diethylene glycol monomethyl ether acetate as a solvent and azobisisobutyronitrile as a catalyst. The mixture was stirred at 80° C. for 2 to 6 hours in a nitrogen atmosphere to obtain a resin solution. This resin solution was cooled and glycidylmethacrylate was reacted with the above resin to add in addition molar ratio of 0.12 to 1 mol of a carboxyl group of the resin at 95 to 105° C. for 16 hours by using methyl hydroquinone as a polymerization inhibitors and the tetrabutyl phosphoniumbromide as a catalyst. After cooling, the reaction product was taken out to produce an organic binder (A3-1). This resin (A3-1) had a weight average molecular weight of about 10,000, an acid value of 59 mg KOH/g and a double bond equivalent of 950. In this case, the weight average of molecular weight of the obtained copolymer resin was measured by high-speed liquid chromatography using a pump LC-6AD manufactured by Shimazu Corporation and three columns; Columns Shodex (trademark) KF-804, KF-803 and KF-802, manufactured by Showa Denko K.K. connected in series. Moreover, diethylene glycol monomethyl ether acetate was added to the resin to adjust a solid concentration of 60%.

### Synthetic Example 2

An organic binder (B3-1) was produced in the same manner as in the above Synthetic Example 1 except that the ratio by mol of methylmethacrylate to methacrylic acid was altered to 0.87:0.13 and the addition reaction of glycidylmethacrylate was not conducted. This organic binder (B3-1) had a weight average molecular weight of about 10,000 and an acid value of 74 mg KOH/g. Diethylene glycol monomethyl ether acetate was added to the organic binder to adjust a solid concentration of 40%.

As the glass powder, a lead-free glass powder including Bi₂O₃, B₂O₃, ZnO, SiO₂ and BaO was pulverized into a powder having an average particle diameter of 1.6 mm prior to use. Glass powders having softening points as shown in the following Table 1 were used.

TABLE 1

| | Softening |
|---|---|
| | point/° C. |
| Glass powder (A1-1) | 470 |
| Glass powder (A1-2) | 500 |
| Glass powder (A1-3) | 520 |
| Glass powder (A1-4) | 560 |
| Glass powder (A1-5) | 580 |

The softening point of the glass powder was measured by a differential thermal analysis wherein an alumina powder was used as a standard material and the temperature of the system was raised at a temperature rise rate of 10° C./min. to 800° C. from ambient temperature to define the temperature of the peak top in the obtained endothermic peak as the softening point.

A composition having the following ingredients and ratios was blended, stirred by a stirrer and kneaded by a three-role mill to form a paste.

### Composition Example 1

Photocurable conductive paste for the upper layer (white system);

| | | |
|---|---|---|
| Organic binder (A3-1) | 166.7 | parts |
| Trimethylolpropanetriacrylate | 60.0 | parts |
| 2-dimethylamino-2-(4-methylbenzyl)-1-(4- | 5.0 | parts |
| morpholinophenyl)butanone | | |
| Solvesso #200 | 20.0 | parts |
| Silver powder | 500.0 | parts |
| Glass powder (A1-1) | 35.0 | parts |
| Antifoaming/leveling agent | 6.0 | parts |

### Composition Example 2

The same composition as Composition Example 1, except that the glass powder (A1-1) was changed to a glass powder (A1-2).

### Composition Example 3

The same composition as Composition Example 1, except that the glass powder (A1-1) was changed to a glass powder (A1-3).

### Composition Example 4

The same composition as Composition Example 1, except that the glass powder (A1-1) was changed to a glass powder (A1-4).

### Composition Example 5

The same composition as Composition Example 1, except that the glass powder (A1-1) was changed to a glass powder (A1-5).

Photocurable black paste for the lower layer (black system):

### Composition Example 6

| | | |
|---|---|---|
| Organic binder (B3-1) | 250.0 | parts |
| Trimethylolpropanetriacrylate | 80.0 | parts |
| 2-methyl-1-[4-(methylthio)phenyl]-2- | 15.0 | parts |
| morpholinopropan-1-one | | |
| 2,2,4-trimethyl-1,3-pentanediolmonoisobutylate | 40.0 | parts |
| Tricobalt tetroxide | 40.0 | parts |
| Lanthanum composite oxide microparticle | 10.0 | parts |
| (La_{0.7}Sr_{0.3}CoO₃) | | |
| Glass powder (A1-1) | 50.0 | parts |
| Stabilizer | 1.0 | parts |
| Antifoaming/leveling agent | 6.0 | parts |

With regard to combinations of the photocurable black paste for the lower layer (black layer) and photocurable conductive paste for the upper layer (white layer), a variation in layer resistance between the white layer and ITO as a function of high-temperature heat history after baking was measured. Also, a variation in layer resistance between the white layer and ITO as a function of the baking time was measured. The evaluation methods are as follows.

### Black Layer Resistance

An evaluation paste was applied to the entire surface of a glass substrate with an ITO film by using a 300 mesh polyester screen, and then dried at 90° C. for 15 hours in a far-infrared drying furnace to form a coating film. Next, the upper layer (white) conductive paste was applied to the entire surface of the coating film by a 300 mesh polyester screen, and then dried at 90° C. for 15 minutes in a far-infrared drying furnace to form a two-layer coating film having satisfactory characteristics concerning dry to touch. Then, using a negative mask enabling the formation of a line having a pattern dimension of 5 mm×100 mm, the coating film was exposed to light at an integral dose of 300 mJ/cm² on the composition and then developed for 20 seconds by using an aqueous 0.4 wt % Na₂CO₃ solution kept at 30° C., followed by washing with water. Finally, the temperature of the substrate was raised at a rate of 14° C./min. in an air atmosphere and then baked at 590° C. for 10 minutes to manufacture a substrate (baking condition 1). In order to measure the resistance of the black layer sandwiched between the ITO film and the silver electrode, a probe of a tester (trade name: HIOKI 3540 mΩHITESTER) was attached to each of the ITO film and the silver electrode to measure the resistance (R1).

The following conditions were used as baking condition 2: temperature rise rate: 14° C./min., 590° C. and 30 minutes, and the substrate baked in this condition was subjected to a test to measure the resistance (R2).

A variation in resistance as a function of the heating time was calculated from the following equation.

Variation in resistance=R2/R1

The adhesion was evaluated in the following manner: the bus electrode formed part of the substrate manufacture in each of the baking conditions 1 and 2 was subjected to a peeling test using an adhesive tape to observe whether or not the pattern was peeled and rated as ◯ to X.
◯: Not peeled
Δ: Partly peeled
X: Entirely peeled
   The results of the evaluations are shown in Table 2.

TABLE 2

| | Exam. 1 | Exam. 2 | Exam. 3 | Comp. 1 | Comp. 2 |
|---|---|---|---|---|---|
| Lower layer | Composition | Composition | Composition | Composition | Composition |
| (black) paste | example 6 | example 6 | example 6 | example 6 | example 6 |
| Upper layer | Composition | Composition | Composition | Composition | Composition |
| (white) paste | example 3 | example 4 | example 5 | example 1 | example 2 |
| Softening point (° C.) | 470 | 470 | 470 | 470 | 470 |
| of black glass | | | | | |
| Softening point (° C.) | 520 | 560 | 580 | 470 | 500 |
| of white glass | | | | | |
| R2/R1 | 1.61 | 1.15 | 1.17 | 3.90 | 5.56 |
| Adhesion | ◯ | ◯ | ◯ | ◯ | ◯ |
| (baking condition 1) | | | | | |
| Adhesion | ◯ | ◯ | ◯ | ◯ | ◯ |
| (baking condition 2) | | | | | |

As is clear from the results shown in Table 2, the paste according to the composition of the present invention exhibited stable layer conductivity across the black layer between the two layers of the double layer bus electrode, which layers differ in contrast as compared with a paste of a comparative composition.

What is claimed is:

1. A plasma display panel provided with a front glass substrate comprising a bus electrode having a double layer structure consisting of a white layer and a black layer and a black pattern, wherein the white layer is formed using a photocurable conductive paste containing a glass powder (A1) having a softening point 40° C. or more higher than that of a glass powder (B1) contained in a black paste to be used in a lower layer of the bus electrode, a conductive powder (A2), an organic binder (A3), a photopolymerizable monomer (A4) and a photopolymerization initiator (A5), and the black layer and black pattern are formed using a photocurable black paste containing a glass powder (B1) having a softening point 40° C. or more lower than that of a glass powder (A1) contained in a photocurable conductive paste to be used in an upper layer, a heat-resistant black pigment (B2), an organic binder (B3), a photopolymerizable monomer (B4) and a photopolymerization initiator (B5).

2. A bus electrode having a double-layer structure consisting of a white layer and a black layer, wherein a difference in glass softening point between a glass powder (A1) contained in the white layer and a glass powder (B1) contained in the black layer is 40° C. or more, the softening point of the glass powder (A1) is 520 to 600° C. and the black layer contains a heat-resistant black pigment (B2).

3. The bus electrode according to claim 2, wherein the heat-resistant black pigment (B2) is tricobalt tetroxide.
